(19) United States
(12) Patent Application Publication
(10) Pub. No.: US 2017/0057160 A1
(43) Pub. Date: Mar. 2, 2017

(54) LARGE SCALE ROOM TEMPERATURE POLYMER ADVANCED MANUFACTURING

(71) Applicant: UT-BATTELLE, LLC, OAK RIDGE, TN (US)

(72) Inventors: Chad E. Duty, Loudon, TN (US); Vlastimil KUNC, Concord, TN (US); Lonnie J. LOVE, Knoxville, TN (US); Charles L. CARNAL, Cookeville, TN (US); Randal F. LIND, Loudon, TN (US); Peter D. LLOYD, Knoxville, TN (US); Orlando RIOS, Knoxville, TN (US)

(73) Assignee: UT-BATTELLE, LLC, OAK RIDGE, TN (US)

(21) Appl. No.: 15/348,366

(22) Filed: Nov. 10, 2016

Related U.S. Application Data
(62) Division of application No. 14/143,989, filed on Dec. 30, 2013.

(51) Int. Cl. B29C 67/00; B33Y 10/00

(52) U.S. Cl. CPC B29C 67/0055; B33Y 10/00; B29K 2025/08

(57) ABSTRACT

A manufactured component, method and apparatus for advanced manufacturing that includes a nozzle for extruding a working material, wherein the polymeric working material includes a carbon fiber reinforced polymer. The build of the component takes place on a work surface at atmospheric temperatures.

### CROSS REFERENCE TO RELATED APPLICATION

This application is a divisional of U.S. patent application Ser. No. 14/143,989, filed on 30 Dec. 2013. The co-pending parent application is hereby incorporated by reference herein in its entirety and is made a part hereof, including but not limited to those portions which specifically appear hereinafter.

### GOVERNMENT RIGHTS

This invention was made with government support under Contract No. DE-AC05-00OR22725 awarded by the U.S. Department of Energy. The government has certain rights in the invention.

### FIELD OF THE INVENTION

The present invention relates to materials and methods for additive manufacturing that do not require an oven or heated bed.

### BACKGROUND OF THE INVENTION

Advanced manufacturing, also referred to as additive manufacturing, may be used to quickly and efficiently manufacture complex three-dimensional components layer-by-layer, effectively forming the complex component. Such advanced manufacturing may be accomplished using polymers, alloys, powders, solid wire or similar feed stock materials that transition from a liquid or granular state to a cured, solid component.

Polymer-based advanced manufacturing is presently accomplished by several technologies that rely on feeding polymer materials through a nozzle that is precisely located over a preheated polymer substrate. Parts are manufactured by the deposition of new layers of materials above the previously deposited layers. Unlike rapid prototyping processes, advanced manufacturing is intended to produce a functional component constructed with materials that have strength and properties relevant to engineering applications. On the contrary, rapid prototyping processes typically produce exemplary models that are not production ready.

In general, advanced manufacturing selectively adds material in a layered format enabling the efficient fabrication of incredibly complex components. Unlike subtractive techniques that require additional time and energy to remove unwanted material, advanced manufacturing deposits material only where it is needed making very efficient use of both energy and raw materials. This can lead to significant time, energy, and cost savings in the manufacture of highly advanced components for the automotive, biomedical, aerospace and robotic industries. In fact, advanced manufacturing is a manufacturing technique in which it may be faster, cheaper, and more energy efficient to make more complex parts. However, wide scale adoption of this technology requires a non-incremental improvement in production rates and component scale. One specific challenge is that the material is deposited at an elevated temperature inside a size-constrained oven or on a heated bed to minimize temperature gradients in the parts. These temperature gradients manifest themselves as residual stress. Residual stress is one major concern in the manufacture of metal and polymer-matrix composites, especially the effects on damage and failure behavior. While many existing low-cost systems fabricate parts at room temperature, as part sizes increase, the residual stress buildup causes the parts to warp and deform.

Conventional polymer extrusion systems feed a polymer filament into a liquefier to extrude a material. Existing materials experience expansion upon melting and contraction upon cooling due to their coefficient of thermal expansion (CTE). If a part is manufactured by depositing hot material over cool material, the constrained cooling manifests itself as residual stress which manifests itself as curl and warp. To overcome this problem, conventional fused deposition modeling (FDM) advanced systems use an oven or heated bed to control the part temperature. The oven temperature is usually kept close to the glass transition temperature of the material typically in the range of 120° C. to 200° C. By keeping the part at a constant temperature, it is possible to minimize temperature gradients and cool the part in a uniform manner to reduce residual stress induced distortion.

While this approach is very successful at manufacturing complex parts, the utilization of an oven introduces many constraints. First, the oven requires significant power, especially for higher temperature and larger parts. If materials change, it also takes time to get the oven up to the proper operating temperate. Temperature gradients within the oven introduce distortions and dimensional variability in parts as well. Variations in parts may occur depending upon where in the oven a part is manufactured. For instance, a part manufactured in the back left corner of the oven may be dimensionally distinct from a part manufactured in the front right corner of the oven. Everything else was identical. Oven temperature in the back left corner may slightly vary from a temperature in the front right resulting in a slight distortion of the part.

Another constraint introduced by the oven or heated bed is a limitation on the build envelope size. Conventional build systems using ovens typically require a limited build size of 36″×36″×24″. As such, the resulting builds must fit within this envelope or be constructed in assembled stages thereby increasing complexity and cost and limiting strength and engineering flexibility.

### SUMMARY OF THE INVENTION

Development of new materials, extrusion and deposition technologies that enable “oven-less” advanced manufacturing at room or ambient temperatures will provide significant advancement in the state of the art, removing size and temperature constraints from future advanced manufacturing systems. One focus of this invention is the use of carbon fiber reinforcements in polymer filaments and/or polymer pellets to aid in structural stability, increased strength and increased stiffness.

According to a preferred embodiment of this invention, the addition of carbon fiber reinforcements to feed polymers (such as ABS, Nylon, Ultem, etc.) lowers the net Coefficient of Thermal Expansion (CTE) of the materials while also increasing the strength and stiffness of the materials. The magnitude of this reduction is sufficient enough to enable room temperature manufacturing of a part without an oven or heated table.

As described, carbon fiber reinforced polymers for use in advanced manufacturing result in a stabilized part, significantly reduced or eliminated distortion, and omission of the need for an oven or a heated bed, thus allowing for large scale part production and reduced energy usage.

Other objects and advantages will be apparent to those skilled in the art from the following detailed description taken in conjunction with the appended claims and drawings.

### BRIEF DESCRIPTION OF THE DRAWINGS

FIG. 1 is a schematic of a conventional polymer extrusion system that feeds a polymer filament into a liquefier to extrude a material.

FIG. 2 is a schematic of a system according to one embodiment of this invention.

FIG. 3 is a schematic of a nozzle according to one embodiment of this invention.

FIG. 4 is a top view of a component manufactured with a conventional polymer side-by-side with a component manufactured with carbon fiber reinforced polymer.

FIG. 5 is a table showing the Young's Modulus of various components with varying carbon fiber content.

### DETAILED DESCRIPTION OF THE INVENTION

The present invention provides a component manufactured using an advanced manufacturing process wherein a supply of working material including a carbon-fiber reinforced polymer is provided to a deposition system. The working material is then deposited in a desired position through a nozzle during a build of the component. The build occurs at atmospheric temperature and outside of the confines or limitations of an oven, heated bed or similar system.

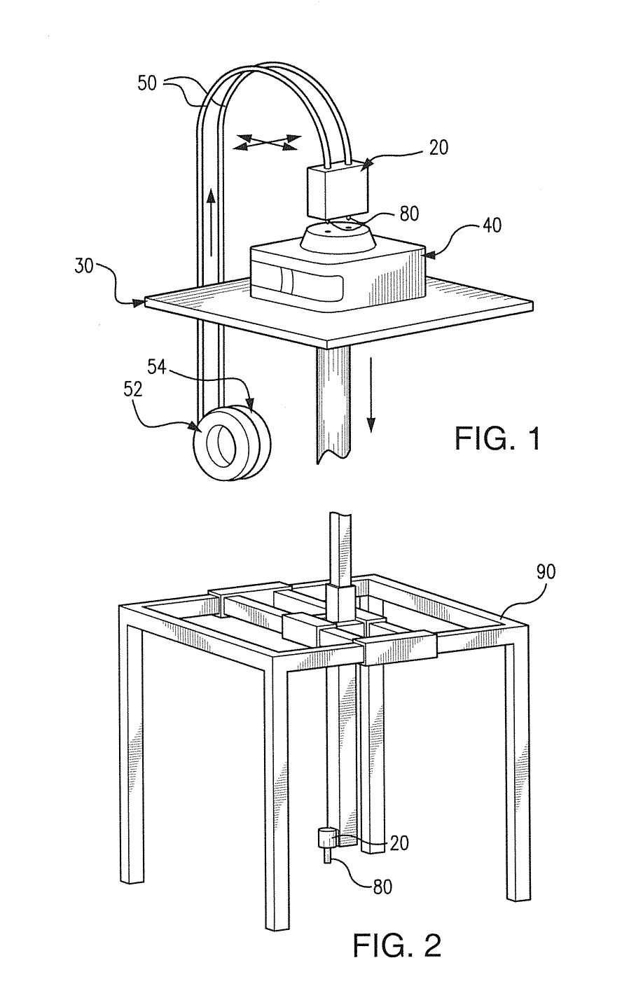

Conventional polymer extrusion systems feed a polymer filament into a liquefier to extrude a material, such as shown in FIG. 1. As shown a conventional polymer extrusion system uses a moveable print head 20 positioned with respect to a work surface 30 to create a desired work piece, component, or part 40. As shown in FIG. 1, a filament 50 may be fed through the print head 20 using drive wheels or a similar mechanism to draw the filament 50 through a heating element 70 to liquefy and extrude the feed material through a nozzle 80 and onto the part 40. As shown in FIG. 1, multiple filaments 50 may be used including a working material 52 and/or a support material 54. In this manner, complex structures may be constructed using the support material 54 for structural support of the working material 52 within the part 40.

Suitable polymers include, for instance, ABS, polycarbonate, PLA, Ultem, Nylon, or PPSF/PPSU. The control of the motion of the extruder and/or the output of the extruder controls the development of a part. Different materials provide different mechanical properties. For example, ABS is a low cost durable material. Ultem is a very strong, stiff high temperature material ideal for tooling. Polycarbonate is a durable material that can be used for functional parts. PPSF/PPSU is a sterilizable, strong high-performance plastic ideal for biomedical applications.

As described above, these materials typically experience expansion upon melting and contraction upon cooling due to their coefficient of thermal expansion (CTE). If a part is manufactured by depositing hot material over cool material, the constrained cooling manifests itself as residual stress which manifests itself as curl and warp on the finished part. As part sizes get larger, the magnitude of curl and warp increases. Traditionally, conventional fused deposition modeling (FDM) advanced systems use an oven or heated bed to control the part temperature which may be inexact and inconsistent. The subject invention results in a system capable of production at atmospheric temperature.

As used herein, the term “atmospheric temperature” is intended to be synonymous with “room temperature” or “ambient temperature,” that is, the temperature inside a temperature-controlled building or the temperature of the surroundings. It is intended that a build according to a preferred embodiment of this invention will occur in a building, room, environment or space that is maintained or exists at temperatures typically between 10° and 30° C., and, in any event, well below 120° C. The term “atmospheric temperature” is not intended to include elevated temperatures within a chamber or oven or heated plate outside of the range of the surroundings.

Although not required, the subject invention may be used in connection with large scale polymer advanced manufacturing such as the schematic shown in FIG. 1 and/or a system such as shown in FIG. 2. FIG. 2 shows a frame or gantry 90 for containing a build. The gantry 90 preferably includes a print head 20, such as described above, that is moveable through the x, y and/or z-axis. In another example, the print head 20 is stationary and the part 40 is moveable through the x, y and/or z-axis. The print head 20 preferably accommodates a supply of feed or working material, such as a filament 50 or pelletized material, and a deposition nozzle 80. The supply of working material may be onboard the deposition arm and/or remotely supplied from a coil in the case of the filament 50 or a hopper for pelletized material, or similar storage vessel.

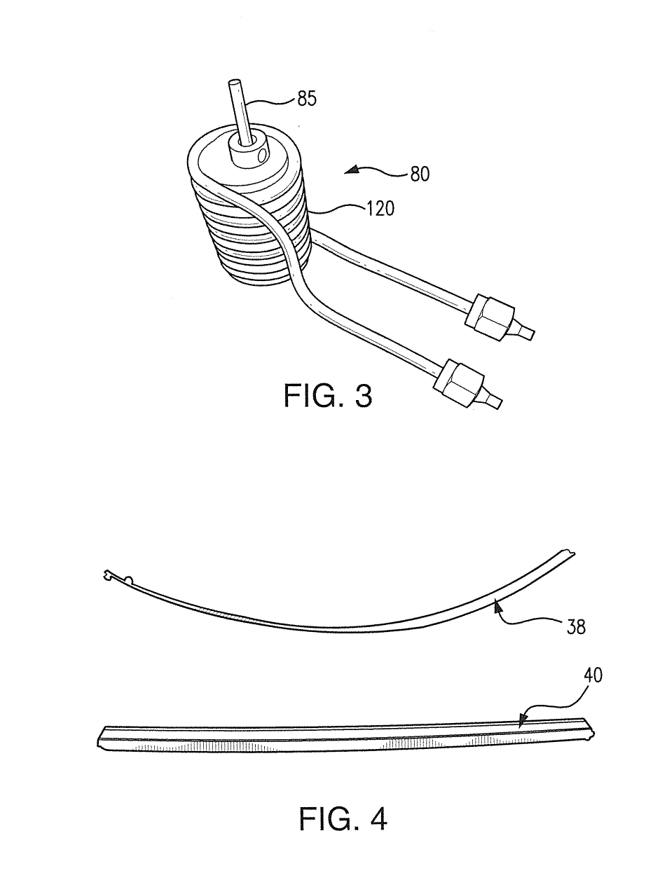

According to a preferred embodiment of the invention, a method of advanced manufacturing includes the steps of providing an apparatus for advanced manufacturing, for instance the gantry system shown in FIG. 2. The apparatus preferably includes a nozzle 80 for extruding a material, such as shown in FIG. 1 or 3. The nozzle 80 preferably operably contacts a polymeric working material that is reinforced with carbon fiber (CF). FIG. 3 shows one embodiment of the nozzle 80 including a barrel 85 through which the working material is provided and from which the working material is directly deposited on the build. An induction coil 120 or alternative heat source may be positioned on or in connection with the nozzle 80 to heat the working material to a desired temperature and/or flow rate. As a result, the nozzle 80 preferably deposits the working material in an appropriate position in space during the build.

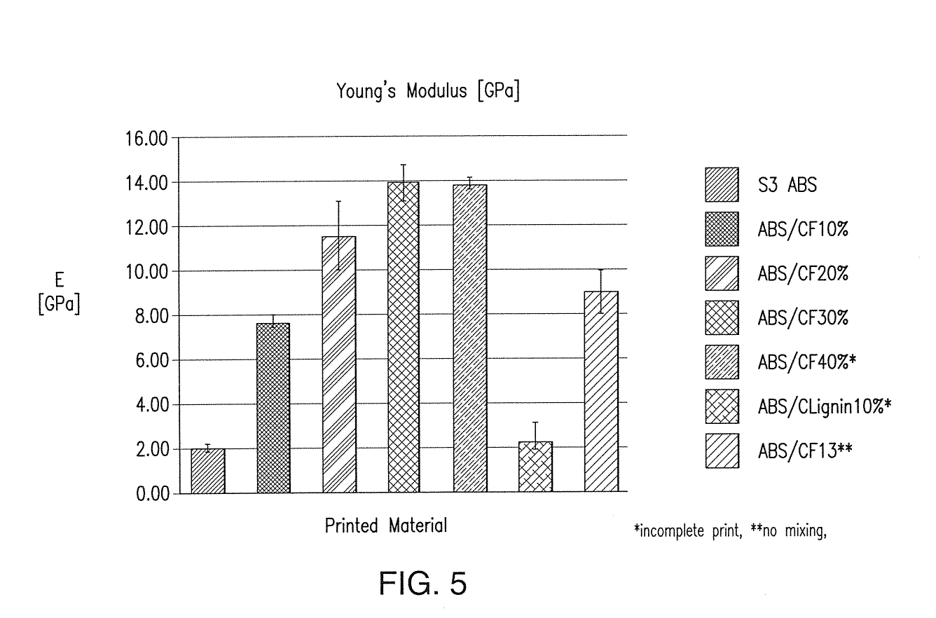

FIG. 4 shows an ABS part that was printed on an FDM machine without CF reinforcement (part 38 on top) and with CF reinforcement (part 40 on bottom). Furthermore, follow on experiments verified that the CF filled parts manufactured at room temperature had approximately the same distortion as non-CF parts manufactured in an oven. Therefore, the introduction of CF into polymers for advanced manufacturing can eliminate the need for an oven or heated bed. The loading percentage is relatively low (10-40%, such as shown in FIG. 5 described below).

The basic phenomenon has proven to be scale invariant. Large scale advanced systems were implemented using the methods described herein. Rather than extruding a filament into a part, the system utilized pelletized raw materials in hoppers or bins to parts. Such parts were manufactured using a large extruder that converts pellets to a molten extrusion (rather than a filament to an extrusion). Such parts may be manufactured at atmospheric or room temperature on an unheated table. For example, an ABS part has 1.67 inches of distortion at the ends due to curl from residual stress. An ABS part with 13% carbon fiber may be manufactured with the same processing parameters and conditions and show no measurable distortion.

The ability to manufacture parts at room temperature opens many opportunities for future advanced manufacturing systems. First, it is possible to integrate sensors and actuators directly into the deposition head to enable greater capabilities. Sensors can include flow measurement, temperature measurement, vision systems, etc. Actuators can include additional degrees of freedom for the deposition head (tilt and yaw), contouring fixtures to provide a smoother finish, machine tools for final finishing, and other improvements. This was not possible previously due to the high temperature and size limitation within the oven or heated bed. Second, it is possible to expand from manufacturing a part to manufacturing a system. Room temperature deposition enables manufacturing in an open environment.

Robotic pick and place equipment can emplace sensors, actuators, batteries, wiring, etc. directly into the structure during the manufacturing process. Finally, room temperature deposition enables boundless size. There is no size limitation due to having to control the build environment (temperature).

FIG. 5 is a table showing the improved stiffness characteristics of an ABS component with various levels of carbon fiber content. As shown, the component exhibits significantly stiffer characteristics in the 10-40% content range.

While there has been shown and described what are at present considered the preferred embodiments of the invention, it will be obvious to those skilled in the art that various changes and modifications can be prepared therein without departing from the scope of the inventions defined by the appended claims.

What is claimed is:

1. A process for manufacturing a component using fused deposition modeling comprising the steps of:
providing a nozzle for directing a desired flow of a working material, wherein the working material comprises a polymer reinforced with carbon fiber; and
building up the component on a work surface at atmospheric temperature.

2. The process of claim 1 wherein the working material comprises at least one of ABS, polycarbonate, PLA, Ultem, Nylon, PPSF/PPSU reinforced with between 1% and 40% carbon fiber.

3. The process of claim 1 wherein the working material is provided in pelletized form to a heating element, the heating element positioned with respect to the nozzle.

4. The process of claim 1 wherein the work surface is not heated.

5. The process of claim 4 further comprising depositing a layer of heated carbon-fiber reinforced polymer on a further layer of cooled carbon-fiber reinforced polymer on the work surface.

6. The process of claim 1 further comprising:
positioning at least one of a sensor, actuator, battery, wire within the component during a build of the component.

7. The process of claim 1 wherein atmospheric temperature is between 10 and 30° C.

8. The process of claim 1 wherein atmospheric temperature is below 120° C.

9. The process of claim 1, further comprising:
providing a hopper for pellets of the carbon-fiber reinforced polymer;
converting the pellets from the hopper to a molten extrusion in an extruder including the nozzle;
depositing the molten extrusion on an unheated work surface disposed adjacent to the extruder, wherein the work surface is open to and in contact with a surrounding atmospheric temperature.

10. The process of claim 9, wherein the nozzle includes a heating element, and the nozzle is disposed over the unheated work surface.

11. The process of claim 10, further comprising depositing the molten extrusion by moving the nozzle through at least two axes of travel within a gantry disposed over the unheated work surface and open to the surrounding atmospheric temperature.

12. The process of claim 9 wherein the carbon-fiber reinforced polymer cools by contact with the atmospheric temperature from a first temperature of the molten extrusion to a second temperature that is less than the first temperature.

13. A process for manufacturing a component using fused deposition modeling comprising the steps of:
providing a supply of working material including a carbon-fiber reinforced polymer, in pelletized form;
converting the pelletized form to a molten extrusion;
depositing the molten extrusion in a desired position through a nozzle during a build of the component; and
wherein the build takes place at atmospheric temperature.

14. The process of claim 13 wherein the build occurs within a gantry and the nozzle moves through at least two axes of travel within the gantry.

15. The process of claim 13 further comprising a heating element positioned with respect to the nozzle.

16. The process of claim 15 wherein the heating element comprises a coil positioned around the nozzle.

17. The process of claim 13 wherein atmospheric temperature is between 10 and 30° C.

18. The process of claim 13 wherein the build occurs on an unheated work surface.

19. The process of claim 13 wherein the working material comprises ABS reinforced with between 10% and 40% carbon fiber.

20. The process of claim 13 further comprising:
positioning at least one of a sensor, actuator, battery, wire within the component during the build.
